(19) United States
(12) Patent Application Publication
(10) Pub. No.: US 2011/0122387 A1
(43) Pub. Date: May 26, 2011

(54) SYSTEM AND METHOD FOR LIGHT SOURCE EMPLOYING LASER-PRODUCED PLASMA

(75) Inventors: Yezheng Tao, San Diego, CA (US); Mark Tillack, La Jolla, CA (US)

(73) Assignee: THE REGENTS OF THE UNIVERSITY OF CALIFORNIA, Oakland, CA (US)

(21) Appl. No.: 12/992,889

(22) PCT Filed: May 12, 2009
(86) PCT No.: PCT/US2009/043614

§ 371 Date: Feb. 1, 2011

Related U.S. Application Data
(60) Provisional application No. 61/052,857, filed on May 13, 2008.

(51) Int. Cl. G03B 27/54; G21K 5/00

(52) U.S. Cl. 355/67; 250/492.1

(57) ABSTRACT

A system and method of generating radiation are disclosed. In at least some embodiments, the system is suitable for use as (or as part of) an extreme ultraviolet lithography (EUVL) light source. Also, in at least some embodiments, the system includes a laser source for generating a laser pulse, a target including a solid material, and a lens device that assists in directing the laser pulse toward the target. At least a portion of the target becomes a plasma that emits radiation upon being exposed to the laser pulse. The laser pulse has a pulse duration of at least 50 nanoseconds and, in at least some such embodiments, has a pulse duration of at least 100 nanoseconds.

### CROSS-REFERENCE TO RELATED APPLICATIONS

The present application claims priority to U.S. patent application Ser. No. 61/052,857, filed on May 13, 2008, the entire content of which is incorporated by reference herein.

### STATEMENT REGARDING FEDERALLY SPONSORED RESEARCH OR DEVELOPMENT

--

### FIELD OF THE INVENTION

The present invention relates to light sources and, more particularly, to light sources involving the generation of laser-produced plasmas.

### BACKGROUND OF THE INVENTION

In order to achieve higher density semiconductor circuits, it is desired that higher optical-resolution lithographic light sources be developed. Since resolution scales linearly with wavelength, many in the semiconductor industry view extreme ultraviolet lithography (EUVL) technology as a promising technology that in coming years will be used to produce smaller and faster microchips with feature sizes of 32 nm or less.

Several issues remain to be addressed before EUVL can be successfully applied in high volume semiconductor production. One is the need to develop an inexpensive, high power (e.g., greater than 10 W) or at least medium power (e.g., between 0.1 and 1.0 W, or alternatively between 0.1 and 10 W) EUVL light source, as well as a long-lifetime EUVL light source. Laser produced plasma and discharge-produced plasma (DPP) are the main two candidates for a medium power EUVL light source. To date, the only commercially available medium power EUVL source is based on DPP. However, the collection efficiency of DPP is only several percent. As for EUVL light sources involving the generation of laser-produced plasmas (LPPs), while recent international efforts have resulted in great progress in enhancing the conversion efficiency achieved in such light sources, several problematic issues remain to be addressed.

More particularly with respect to LPP-type EUVL light sources, such light sources can employ a high repetition rate laser (10-100 kHz) with 100-1000 mJ pulse energy, and operate by irradiating a metal target with the high-power laser radiation to cause the target material to be vaporized into a plasma with excited metal atoms and ions. The excited metal atoms and ions in turn emit the desired soft X-rays, which are then collected and transported onto a photoresist coated wafer. Further detailed information regarding the design of such light sources can be obtained in “Extreme ultraviolet light sources for use in semiconductor lithography-state of the art and future development” by Uwe Stamm (J. Phys. D: Appl. Phys. 37 (2004) 3244-3253), which is hereby incorporated by reference herein.

Notwithstanding the promise of such light sources, a remaining significant challenge in implementing EUVL light sources is to develop a powerful, long life and affordable light source capable of achieving high in-band conversion efficiency. Currently, the major commercially available in-band EUV light source with medium power (again, for example, between 0.1 and 1.0 Watt, or between 0.1 and 10 Watts) uses discharge-pumped Xe plasma. However, the collection efficiency of the EUV light is very low—of the order of several percent. Also, while laser produced Sn-based plasma can reach Watt-scale power when a conventional diode-pumped Nd:YAG laser is used, such a conventional diode-pumped Nd:YAG laser with several 100 W can be undesirably expensive.

Other conventional MAT light sources employ CO₂ lasers. Such lasers, which generate pulses having a duration of 25 nanoseconds or less, allow for high in-band conversion efficiency. More particularly, such lasers are typically based upon a master oscillator power amplifier (MOPA) structure, and operate by producing a short seeding pulse, and a series of amplifiers. Further, a radio frequency (RF) excited continuous wave (CW) high power CO₂ laser is often employed as the amplifier. Additionally, typically many stages of pre-amplifiers are required to efficiently extract power from the final amplifier, given the lengths of the pulses that are being generated by the lasers (again, as mentioned above, 25 nanoseconds or less).

Although EUVL light sources employing CO₂ lasers can produce high conversion efficiency, the lasers are complicated and expensive given their numerous components, and have an undesirably low extraction efficiency. For example, extraction efficiency of the final amplifier using a 20 ns pulse is often less than 20%. Thus, such EUVL light sources are less desirable for many applications such as developing photo-resist, and metrology of masks and optics.

For at least these reasons, it would be advantageous if an improved light source for generation of LPP(s) is developed. It would particularly be advantageous if in at least some embodiments, the light source operated in a manner that improved the efficiency and the power achieved from the light source, while minimizing the overall complexity and/or cost of the light source cost, relative to conventional light sources. It would additionally be advantageous if such a light source could provide high conversion and extraction efficiency, while mitigating (or at least not exacerbating) the production of debris during LIT generation.

### BRIEF SUMMARY OF THE INVENTION

The present inventors have recognized the above limitations of conventional EUVL light sources. Additionally, among other things, the present inventors have discovered that improved EUVL light sources employing CO₂ lasers could achieve enhanced performance relative to conventional EUVL light sources by designing/operating the CO₂ lasers of those improved EUVL light sources to output pulses of much longer duration (e.g., 50 nanoseconds or longer) than are currently output by conventional EUVL light sources employing CO₂ lasers. The present inventors also have discovered that, in at least some other embodiments of the invention, it is also possible to employ other types of lasers such as Nd:YAG lasers having pulses of much longer duration than are currently output by conventional lasers to achieve improved EUVL light sources.

In at least some embodiments, the present invention relates to a system that includes a laser source for generating a laser pulse, a target including a solid material, and a lens device that assists in directing the laser pulse toward the target. At least a portion of the target becomes a plasma that emits radiation upon being exposed to the laser pulse, and the laser pulse has a pulse duration of at least 50 nanoseconds.

Further, in at least some embodiments, the present invention relates to a system for generating radiation. The system includes a long-duration pulse laser that generates a pulse longer than 100 ns, and a target including a material. At least a portion of the material becomes a plasma upon being exposed to the pulse, and at least one of a radiation emission and a particle omission occurs after the exposure to the pulse.

Additionally, in at least some embodiments, the present invention relates to a method for generating radiation. The method includes generating a laser pulse having a duration longer than 100 ns, and exposing a target made of material to the laser pulse so as to produce a plasma. The exposing of the target to the laser pulse results in a radiation emission.

### BRIEF DESCRIPTION OF THE DRAWINGS

FIG. 1 is a schematic diagram showing an exemplary extreme ultraviolet lithography (EUVL) light source based on laser-produced plasma, in accordance with some embodiments of the present invention;

FIGS. 2A-2D show exemplary experimental results showing the temporal shape of the extreme ultraviolet light (EUV) resulting from EUVL light sources having various pulse durations including pulse lengths that, in accordance with at least some embodiments of the present invention, are very long relative to the pulse lengths of lasers in conventional EUV, light sources; and

FIG. 3 shows exemplary experimental results showing the intensity spectra of EUV light for various pulse durations of the EUVL light source of FIG. 1.

### DETAILED DESCRIPTION OF THE PREFERRED EMBODIMENT

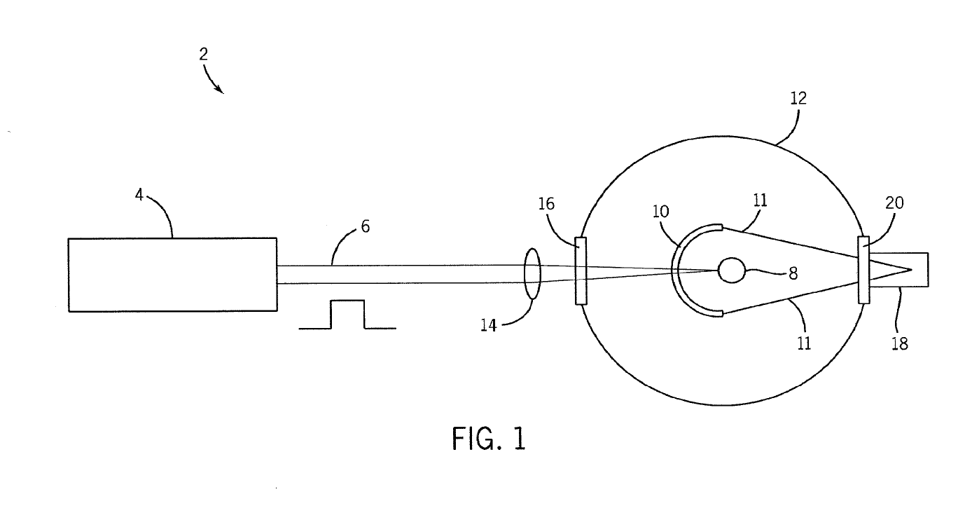

Referring to FIG. 1, a schematic diagram shows an exemplary extreme Ultraviolet lithography (EUVL) light source 2, in accordance with at least some embodiments of the present invention in which the light source involves generation of a laser-produced plasma (LPP). As shown, the light source 2 includes a laser 4 that is capable of repeatedly emitting a laser pulse 6. In the present embodiment, the laser 4 is a carbon dioxide (CO₂) laser configured to emit pulses that are very long in duration by comparison with conventional CO₂ lasers, e.g., pulses having a duration of 50 nanoseconds or more (further for example, 110 ns).

As shown in FIG. 1, the light source 2 operates by focusing repeated laser pulses 6 (one of which is shown) onto a solid density tin (Sn) target 8 such as a high purity tin plate. More particularly as shown, the laser pulses 6 from the laser 4 are focused onto the target 8 at normal incidence by way an F/10 meniscus lens 10, where both the target 8 and the lens 10 are positioned within a vacuum chamber 12. Also in the present embodiment, an additional lens 14 is positioned between the laser 4 and the vacuum chamber 12 that serves to focus the laser pulses 6 onto the lens 10 and thus the target 8, with the laser pulses passing into the vacuum chamber 12 via an entrance window 16. In some embodiments, the light source 2 has a focal spot size (e.g., the diameter of the laser at the point where it intercepts the target) of about 200 μm and a laser intensity of up to 2×10¹⁰ W/cm² or even higher.

Upon focusing the laser pulses 6 onto the target 8, the Sn atoms are vaporized and partially ionized to create a plasma. Excitation of the remaining electrons of the atoms bring about the emission of the EUV light. The lens 10 serves as a collector of EUV light and in turn reflects and focuses that light, as shown by converging lines 11, onto a structure 18 through an exit window 20 in the vacuum chamber 12. The structure 18 can be a wafer or, alternatively, can be a device employed for collecting and focusing the EUV light onto a wafer positioned away from the light source 2.

Notwithstanding the above description, various aspects of the light source 2 can be modified. For example, in other embodiments, other types of Sn targets such as a Sn droplet generator can be employed instead of a solid density tin target. Also for example, various parameters can vary depending upon the arrangement of the various components within the light source 2 and the desired power of the emitted EUV light. As noted above, the pulse duration of the laser pulses 6 can also vary, so long as the pulses are 50 nanoseconds in length or more (e.g., pulses of 50 ns, 100 ns, 200 ns, etc.). In at least some embodiments, the light source 2 can be configured to generate long pulses having a variety of lengths (e.g., variable length pulsing).

In at least some other embodiments, the EUVL light source 2 can be a compact, free-running master oscillator and power amplifier (MOPA) CO₂ laser system that includes a master oscillator and two stages of power amplifiers. Both the oscillator and the amplifiers are transversely excited atmosphere (TEA) CO₂ lasers. A plane-parallel ZnSe output coupler with a reflectivity of 80% is used in the oscillator. The laser pulse from the oscillator is shortened by an air-breakdown-plasma shutter. The plasma shutter is triggered by the free electrons from an air-breakdown plasma induced by a 30 ns Q-switched Nd:YAG laser and pumped by the oscillator itself. The four lasers are synchronized with a digital delay/pulse generator (SRS DG535). Various pulse durations can be achieved by varying the delay time between the oscillator and the Nd:YAG laser. The intensity on the target is amplified to up to 2×10¹⁰ W/cm² by the two amplifiers. The temporal shape and energy of the laser pulse are monitored for each shot.

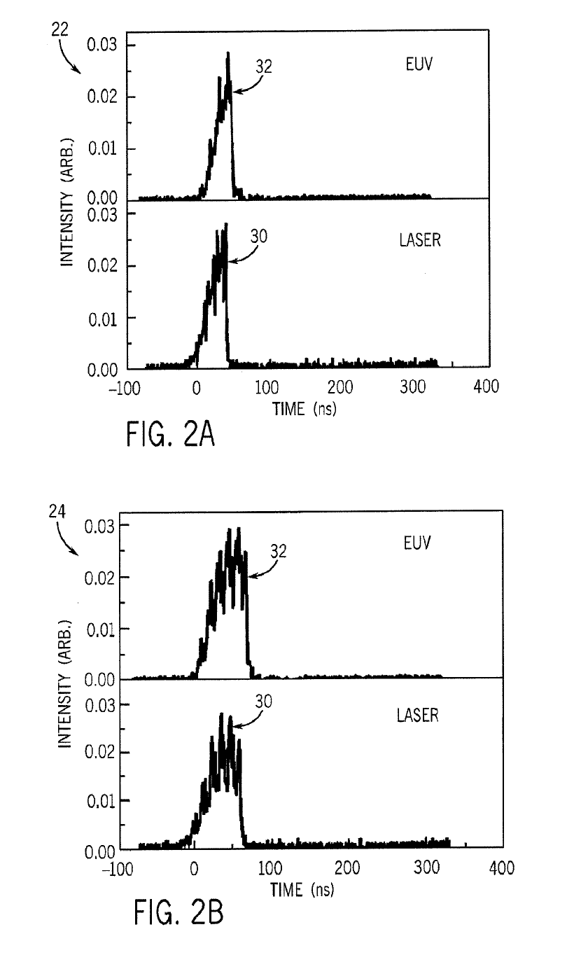

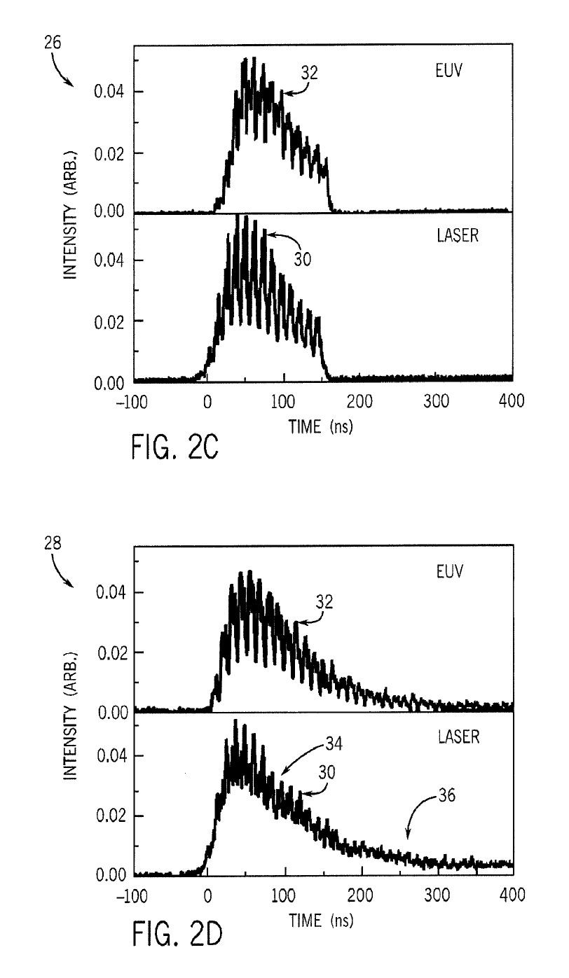

Referring now to FIGS. 2A-2D, exemplary respective graphs 22, 24, 26 and 28 are provided showing both exemplary shapes and durations of a CO₂ laser pulse 30 (e.g., a pulse corresponding to the pulses 6 of FIG. 1) and corresponding shapes and durations of EUV light 32 emitted from a given target (e.g., a target such as the target 8 of FIG. 1) are shown. FIGS. 2A-2D in particular are intended to illustrate the efficacy of generating satisfactory EUV light even when the CO₂ laser pulse 30 is varied from a conventional pulse length to pulse lengths that are much greater than those utilized in conventional BAT light sources (e.g., lengths of 50 ns or more).

FIG. 2A in particular illustrates the EUV light 32 that is produced assuming a conventional CO₂ laser pulse 30 of 25 ns. In contrast, FIGS. 2B, 2C and 2D show exemplary temporal shapes of the EUV light 32 resulting from CO₂ laser pulses 30 having respective durations of 50, 110 and 200 ns, respectively. Generally speaking, the duration of the CO₂ laser pulse 30 is measured at full width at half maximum (FWHM), although other pulse duration measurement methods can be used as well depending upon the embodiment.

As can be seen from each of FIGS. 2A-2D, the temporal shape of the respective EUV light 32 follows (or substantially follows) the temporal shape of the respective laser pulse 30 regardless of whether the length of the laser pulse 30 is 25, 50, 110 or 200 ns. Further as shown, the experimental results illustrate that, generally speaking, as one increases the length of the laser pulse 30, it takes an increasing amount of time for the EUV light 32 to shut off following the end the laser pulse precipitating that EUV light. For example, as shown in FIGS. 2A and 2B, when the laser pulse 30 ends, the EUV light 32 continues for 3-4 ns thereafter. However, as shown in FIGS. 2C and 2D, when the laser pulses 30 end, significant emissions of the EUV light 32 continue to occur long after the ending of the pulse.

Further, to the extent that the laser pulses 30 themselves cannot be switched on and off instantaneously (are not square waves), it is evident that the EUV light 32 produced by the long laser pulses continue at a falling slope 34 and even at short tails 36 having low intensity of the laser pulse 30. In particular, notable EUV light 32 is observed at the un-shortened laser pulse of FIG. 2D at the falling slope and the short tails 34 and 36, respectively, of the laser pulse 30. Thus, even a low intensity slope can efficiently contribute to the generation of the EUV light 32 at long pulse durations.

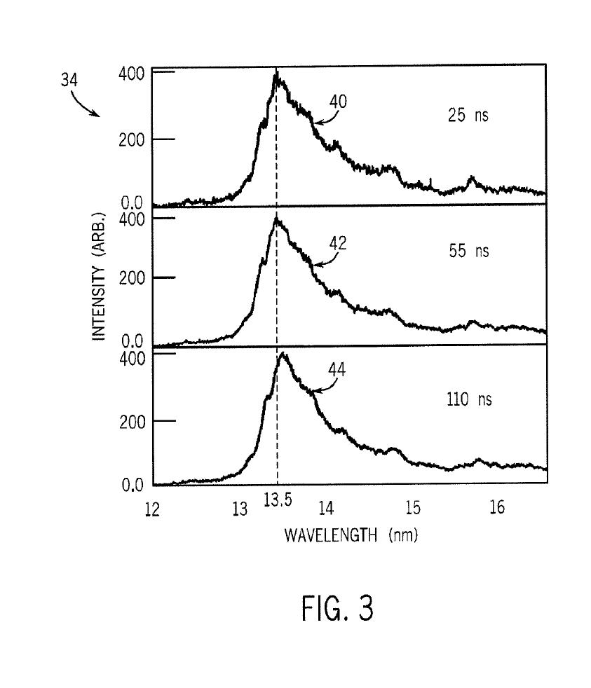

Turning to FIG. 3, laser pulses of long length (at least as long as 110 ns) also can still be used to achieve a high in-band conversion efficiency of the EUV light 32. More particularly, a graph 34 shows exemplary respective EUV (soft x-ray) spectra 40, 42 and 44 emitted from Sn plasma irradiated by laser pulses 6 from the CO₂ laser 4 when the laser pulses have pulse durations of 25, 55 and 110 ns, respectively. FIG. 3 demonstrates that long pulse CO₂ lasers with pulse durations of 55 ns or 110 ns generate at-least the same (or similar) conversion efficiency (CE) as compared with that obtained using a conventional CO₂ laser with pulse durations of only 25 ns. Further as shown, in each case, the spectral peak for each of the pulse durations 25, 55 and 110 ns is located near 13.5 nanometers, and the shapes of each of the spectra are largely identical.

While FIGS. 2A-3 show that the in-band conversion efficiency, spectral shape and peak wavelength of the EUV light emitted as a result of longer laser pulses is (or at least can be) comparable to that resulting from conventional laser pulses, the use of long laser pulses results in other benefits relative to the use of conventional laser pulses. In particular, a long pulse CO₂ laser produces debris that is easier to mitigate as compared with that from a conventional (short pulse) laser. Specifically, it has been observed that the kinetic energy of ions for pulses of all durations (e.g., 25, 55 and 110 ns) is about 2 keV. However, since laser intensities are fixed (or approximately fixed), the energy in a long pulse is higher than that of a short pulse creating extra slow ions. Slow ions are typically easier to mitigate using electric and magnetic fields, and gas etc. Thus, the use of long laser pulses, due to their greater energy and larger number of slow ions, produces debris that can be more easily mitigated relative to the debris produced by the use of conventional (short) laser pulses.

Further, by employing a CO₂ laser with pulses of long duration, the complexity of the light source 2 can be reduced relative to conventional light sources, thus reducing the cost of the CO₂ laser system. Also, such a light source will be of long-life. Additionally, a CO₂ laser with pulses of long duration also is beneficial relative to conventional embodiments insofar as, through the use of such a laser, it is easier to achieve mass-limited target operation for the most commonly used droplet targets with diameters ranging from several 10 μm to 100 μm. Employing a long pulse also makes it easier to align the laser to the target.

Additionally, elongating the pulse duration additionally increases the pulse energy. For example, by modifying the pulse duration from about 25 ns to about 110 ns, the pulse energy increases by about a factor of 4 without any extra cost, thereby making the entire light source 2 much more efficient and inexpensive. Indeed, by employing a laser having pulses of long duration, a narrow-band 13.5 nm EUV light source providing medium power (e.g., between 0.1 and 1.0 W or, alternatively, between 0.1 and 10 W) or even high power (e.g., greater than 10 Watt) can be readily provided. Such a medium power EUV light source is especially applicable for chip testing and developing photo resist, as well as metrology of masks and optics.

In short, the use of a long pulse TEA CO₂ laser results in numerous advantages. First, it is low cost in that it enables at least 50% reduction of the total cost as compared with that driven by a solid state laser. Second, it is efficient in that it allows for efficient conversion from electric to CO₂ laser (10-20%) and from CO₂ laser to 13.5 nm in-band EUV (3%), which makes the whole system very efficient. Third, at least a medium level of power output is possible from a EUVL light source employing such a laser—for example, one Watt of 13.5 nm in-band (2% bandwidth) EUV can be expected from a single CO₂ laser with 100 watt laser power. Fourth, because the EUVL light source provides isolated plasma, there is less ablated material. Fifth, the CO₂ (gas) laser is well known to be suitable for high/heavy duty operation and thus long life.

Notwithstanding the above discussion, the present invention is intended to encompass a variety of embodiments of EUVL, light sources. For example, in one embodiment, the EUVL light source includes a high power CO₂ laser, a high repetition rate target supply system, target alignment and synchronization system, a debris mitigation system, collector, and a metrology system. The laser is a TEA CO₂ laser producing 10.6 μm laser with pulse energy of 1 J and repetition rate of 250 Hz to 1000 Hz. Sn droplets at 250 to 1,000 Hz are used as targets. Magnetic field and ambient gas are used to mitigate debris. A 10-inch concave Mo/Si collector is used to collect the EUV light. Metrology for EUV light is needed. Further, by optimizing the gas mixture ratio of the CO₂ laser, the long tails following the laser pulses can be reduced, thereby reducing the amount of debris that is generated (and also potentially enhancing peak power output). By combining this tail reduction aspect with other technologies (e.g., pre-pulse, magnetic field, and ambient gas technologies) the amount of debris can be substantially mitigated.

Further it is envisioned that, in alternate embodiments, other types of lasers instead of (or in addition to) CO₂ lasers can be utilized, in which the pulses are of similarly long duration as described above and/or in which the pulses are of much greater length than as provided by conventional lasers of the same type. For example, while many conventional Nd:YAG lasers may operate to provide pulses having short durations of between 2 and 10 nanoseconds, in accordance with at least some other embodiments of the present invention, Nd:YAG lasers providing pulses having much longer durations (e.g., durations that are the same as or similar to those mentioned above such as 50 ns or more) are employed. In one such embodiment, an Agilite™ Nd:YAG laser as available from Continuum, Inc. of Santa Clara, Calif. that is modified to have a high repetition rate can be utilized to achieve such operation. By comparison with CO₂ lasers such as those discussed above, the use of an ND:YAG laser has the potential to produce more highly-focused laser energy.

Embodiments of the present invention are intended to be applicable in connection with a variety of different types of light (or radiation) sources employing laser-produced plasmas (LPPs), and in a variety of different circumstances. As already discussed, embodiments of the present invention can be employed in extreme ultraviolet lithography (RAT) light sources such as those used for (or potentially useful in the future in connection with) semiconductor manufacture involving lithography and/or other lithographic procedures, as well as EUV resist development. A variety of applications are also possible in other areas such as EUV metrology, soft x-ray microscopy, and soft x-ray chemistry. Further for example, embodiments of the present invention can be employed in EUV light sources used for microscopy (e.g., medical microscopy) as well as in laser-produced plasma x-ray sources. Additionally for example, embodiments of the present invention can be employed in pulsed laser deposition (PLD) particle sources. In such embodiments, the impacting of the laser pulses upon the target results in the emission of particles (of the target material) that are in turn deposited upon a substrate.

Further, at least some embodiments of the present invention can be implemented in connection with various types of targets, including for example, tin targets and solid density tin targets of various shapes and sizes (e.g., slabs having planar, convex or concave surfaces). The cost of implementation is low, and the technique can be easily coupled into existing designs of laser plasma systems and/or EUVL systems, used in conjunction with existing Sn-doped droplet and low density foam targets, and/or used in combination with conventional methods to mitigate debris such as methods involving the use of buffer gas or electric fields, among others. In at least some embodiments of the invention, a microprocessor or another control mechanism is implemented in connection with the light source 2 (or other light source) to control its operation or a portion thereof (e.g., in connection with pulse generation and delay between two or more pulses).

It is specifically intended that the present invention not be limited to the embodiments and illustrations contained herein, but include modified foams of those embodiments including portions of the embodiments and combinations of elements of different embodiments as come within the scope of the following claims.

We claim:

1. A system comprising:
a laser source for generating a laser pulse;
a target including a solid material; and
a lens device that assists in directing the laser pulse toward the target;
wherein at least a portion of the target becomes a plasma that emits radiation upon being exposed to the laser pulse, and
wherein the laser pulse has a pulse duration of at least 50 nanoseconds.

2. The system of claim 1, wherein the pulse duration is at least 100 nanoseconds.

3. The system of claim 2, wherein the pulse duration is at least 200 nanoseconds, and wherein the laser pulse is a first of a plurality of laser pulses.

4. The system of claim 1, wherein the laser source includes a carbon dioxide laser.

5. The system of claim 1, wherein the laser source includes a Nd:YAG laser.

6. The system of claim 1, wherein the pulse has a power of approximately one Watt.

7. The system of claim 1, further comprising a vacuum chamber within which are situated the target and the lens.

8. The system of claim 7, wherein an additional lens is provided outside of the vacuum chamber between the vacuum chamber and the laser, and wherein the additional lens assists in focusing the laser pulse toward the target.

9. The system of claim 1, wherein a length of a tail of the laser pulse is reduced by optimizing a gas mixture ratio of the CO₂ laser.

10. The system of claim 1, wherein the radiation emitted by the plasma includes extreme ultraviolet light (EUV).

11. An extreme ultraviolet lithography (EUVL) light system including the system of claim 1.

12. The EUVL light system of claim 11, wherein the EUVL light system includes a position at which is placed a microchip wafer, and wherein the EUVL light system additionally includes a microprocessor that controls operation of the laser.

13. The system of claim 1, further including at least one additional component allowing the system to be utilized for at least one of medical microscopy and pulsed laser deposition.

14. A system for generating radiation, the system comprising:
a long-duration pulse laser that generates a pulse longer than 100 ns; and
a target including a material, wherein at least a portion of the material becomes a plasma upon being exposed to the pulse;
wherein at least one of a radiation emission and a particle omission occurs after the exposure to the pulse.

15. The system of claim 14, wherein the pulse has a power of less than 10 Watts.

16. The system of claim 14, wherein the laser is a carbon dioxide laser.

17. The system of claim 14, wherein the laser is a Nd:YAG laser.

18. A method for generating radiation, the method comprising:
generating a laser pulse having a duration longer than 100 ns; and
exposing a target made of material to the laser pulse so as to produce a plasma;
wherein the exposing of the target to the laser pulse results in a radiation emission.

19. The system of claim 18, wherein the laser source includes a carbon dioxide laser.

20. The system of claim 18, wherein the laser source includes a Nd:YAG laser.
